(19) United States
(12) Patent Application Publication
(10) Pub. No.: US 2025/0126630 A1
(43) Pub. Date: Apr. 17, 2025

(54) MANAGING MULTICAST CONFIGURATIONS

(71) Applicant: GOOGLE LLC, Mountain View, CA (US)

(72) Inventor: Chih-Hsiang Wu, Taoyuan City (TW)

(21) Appl. No.: 18/702,573

(22) PCT Filed: Oct. 19, 2022
(86) PCT No.: PCT/US2022/047080

§ 371 Date: Apr. 18, 2024

Related U.S. Application Data
(60) Provisional application No. 63/270,393, filed on Oct. 21, 2021.
(60) Provisional application No. 63/350,209, filed on Jun. 8, 2022.

(51) Int. Cl. H04W 72/30; H04W 72/543

(52) U.S. Cl. CPC H04W 72/30; H04W 72/543

(57) ABSTRACT

A base station can implement a method for configuring a multicast radio bearer (MRB) for a multicast and/or broadcast services (MBS) session. The method may include determining (1502) that the MBS session or the MRB requires uplink resources. The method may also include, based on the determining, selecting (1504) a configuration for the MRB, the configuration including configuration parameters for a user equipment (UE) to receive the MBS session. The method may further include transmitting (1506) the selected configuration to the UE.

### FIELD OF THE DISCLOSURE

This disclosure relates to wireless communications and, more particularly, to enabling setup of radio resources for unicast and multicast communications.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer defined for the Evolved Universal Terrestrial Radio Access (EUTRA) radio interface (see Third Generation Partnership Project (3GPP) specification TS 36.323) and New Radio (NR) (see 3GPP specification TS 38.323) provides sequencing of protocol data units (PDUs) in the uplink direction from a user device (also known as a user equipment or “UE”) to a base station, as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul, in what is referred to as dual connectivity (DC) operation. These network nodes may all be nodes using the same radio access technology (RAT) or may include nodes using different RATs. Example DC configurations include NR-only dual connectivity (NR-DC) and EUTRA and NR dual connectivity (EN-DC). When a UE operates in DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, in single connectivity (SC). The UE in SC only communicates with the MN, via the MCG. A base station and/or the UE determines when the UE should establish a radio connection with another base station. For example, a base station can determine to hand the UE over to another base station, and initiate a handover procedure. The UE in other scenarios can concurrently utilize resources of another RAN node (e.g., a base station or a component of a distributed or disaggregated base station), interconnected by a backhaul.

UEs can use several types of SRBs and DRBs. So-called “SRB1” resources carry RRC messages, which in some cases include NAS messages over the dedicated control channel (DCCH), and “SRB2” resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in SC or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform a PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier in 5G NR. 3GPP has proposed for Release 17 that a 5G NR base station be able to provide multicast and/or broadcast service(s) (MBS) to UEs. MBS can be useful in many content delivery applications, such as transparent IPv4/IPv6 multicast delivery, IPTV, software delivery over wireless, group communications, Internet of Things (IoT) applications, V2X applications, and emergency messages related to public safety, for example.

5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface, while in PTM communications a RAN node transmits a single copy of each MBS data packet to multiple UEs over the radio interface. In some scenarios, however, it is unclear how a base station receives an MBS data packet from a core network and how the base station transmits each MBS data packet to UEs.

### SUMMARY

A base station and/or a core network can utilize the techniques of this disclosure for configuring MBS sessions, radio bearers, and/or logical channels.

In some scenarios, a base station may determine whether to include a configuration parameter in a configuration associated with a radio bearer (e.g., a radio bearer configuration, a configuration of a logical channel associated with the radio bearer, and/or a configuration of a radio link control (RLC) bearer associated with the radio bearer), based on whether the radio bearer is a unicast radio bearer or a multicast radio bearer (MRB). For example, the configuration parameter may be an uplink configuration parameter that is either unnecessary or not allowed for an MRB. As another example, the configuration parameter may be a logical channel group identifier.

Depending on the implementation, an MRB for an MBS session might or might not require a uplink resources. Based on whether the MRB requires uplink resources, the base station can select a configuration for the MRB. The base station can determine whether the MRB requires uplink resources based on, for example, an indication received from the core network, or quality of service (QOS) parameters associated with the MBS session.

Further, a UE can also utilize the techniques of this disclosure to determine how to utilize a radio bearer or logical channel associated with a radio bearer. For example, in some implementations, if the UE receives a logical channel identifier for a logical channel associated with a radio bearer, the UE can determine whether to use the logical channel to transmit data based on whether the radio bearer is a unicast radio bearer or an MRB. In other implementations, the UE can determine whether to use a logical channel associated with an MRB based on whether the UE receives particular configuration parameter(s) associated with the MRB.

One example embodiment of these techniques is a method in a base station for configuring a radio bearer for a UE. The method can be executed by processing hardware and includes: determining whether the radio bearer is a unicast radio bearer or a multicast radio bearer; generating configuration parameters associated with the radio bearer, the generating including: in a first instance, in response to determining that the radio bearer is the unicast radio bearer, including a configuration parameter of a first type in the configuration parameters; and in a second instance, in response to determining that the radio bearer is the multicast radio bearer, not including the configuration parameter of the first type in the configuration parameters; and transmitting the configuration parameters to the UE.

Another example embodiment of these techniques is a method in a base station for configuring an MRB for an MBS session. The method can be executed by processing hardware and includes: determining that the MBS session or the MRB requires uplink resources; based at least on the determining, selecting a configuration for the MRB, the configuration including configuration parameters for a user equipment (UE) to receive the MBS session; and transmitting the selected configuration to the UE.

Yet another example embodiment of these techniques is a base station including processing hardware and configured to implement one of the methods above.

A further example embodiment of these techniques is a method in a core network (CN) for configuring an MBS session. The method can be executed by processing hardware and includes: determining whether the MBS session requires uplink resources; indicating, in a request to configure resources for the MBS session, whether the MBS session requires the uplink resources; and transmitting, to a base station, the request.

Still another example embodiment of these techniques is a system including processing hardware and configured to implement the method above.

Another example embodiment of these techniques is a method in a UE for communicating with a RAN. The method can be executed by processing hardware and includes: receiving, from the RAN, a logical channel identifier for a logical channel associated with a radio bearer; determining that the radio bearer is a multicast radio bearer; and in response to the determining, refraining, by the processing hardware, from transmitting data via the logical channel.

A further example embodiment of these techniques is a method in a UE for communicating with a RAN. The method can be executed by processing hardware and includes: receiving, from the RAN, one or more configuration parameters associated with a multicast radio bearer, the one or more configuration parameters including a logical channel identifier for a logical channel associated with the multicast radio bearer; and transmitting or refraining from transmitting data via the logical channel based on which configuration parameters are included in the one or more configuration parameters.

Still another example embodiment of these techniques is a UE including processing hardware and configured to implement one of the methods above.

### BRIEF DESCRIPTION OF THE DRAWINGS

FIG. 1A is a block diagram of an example system in which the techniques of this disclosure for managing resources for multicast and/or broadcast services (MBS) can be implemented;

FIG. 1B is a block diagram of an example base station in which a central unit (CU) and a distributed unit (DU) can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a base station;

FIG. 3 is a block diagram illustrating example tunnel architectures for MBS sessions and PDU sessions;

FIGS. 4A-4B are messaging diagrams of example scenarios in which a CN and a base station establish a common downlink (DL) tunnel via which the CN can transmit, to the base station, MBS data of an MBS session, for multiple UEs;

FIG. 5 is a flow diagram of an example method for configuring a radio bearer (RB) based on whether the RB is a multicast radio bearer (MRB) or a unicast RB, which can be implemented by a base station of FIG. 1A;

FIG. 6 is a flow diagram of an example method for selecting configuration parameters for a RB based on whether the RB is an MRB or a unicast RB, which can be implemented by a base station of FIG. 1A;

FIG. 7 is a flow diagram of an example method for configuring an MRB for an MBS session based on whether the MRB or MBS session requires uplink (UL) resources, which can be implemented by a base station of FIG. 1A;

FIG. 8 is a flow diagram of an example method for determining whether to configure a configuration parameter for an MRB for an MBS session based on whether the MRB or MBS session requires UL resources, which can be implemented by a base station of FIG. 1A;

FIGS. 9-10 are flow diagrams of example methods for determining whether to request, from a RAN, UL resources for an MBS session, which can be implemented by a CN of FIG. 1A;

FIG. 11 is a flow diagram of an example method for determining whether to configure a logical channel group for an RB based on whether the RB is an MRB or a unicast RB, which can be implemented by a base station of FIG. 1A;

FIG. 12 is a flow diagram of an example method for determining whether to transmit data packets via a logical channel of an RB based on whether the RB is an MRB or a unicast RB, which can be implemented by a UE of FIG. 1A;

FIG. 13 is a flow diagram of an example method for determining whether to transmit data packets via a logical channel of an MRB based on whether particular configuration parameters have been received at a UE, which can be implemented by a UE of FIG. 1A;

FIG. 14 is a flow diagram of an example method for configuring a radio bearer for a UE, which can be implemented by a base station of FIG. 1A;

FIG. 15 is a flow diagram of an example method for configuring an MRB for an MBS session, which can be implemented by a base station of FIG. 1A;

FIG. 16 is a flow diagram of an example method for configuring an MBS session, which can be implemented by a CN of FIG. 1A; and

FIGS. 17-18 are flow diagrams of example methods for communicating with a RAN using the techniques of this disclosure, which can be implemented by a UE of FIG. 1A.

### DETAILED DESCRIPTION OF THE DRAWINGS

Generally speaking, a RAN and/or a CN implement the techniques of this disclosure to manage transmission of multicast and/or broadcast services (MBS). A CN can request that a base station configure a common downlink (DL) tunnel via which the CN can transmit MBS data for an MBS session to the base station, for multiple UEs. In response to the request, the base station transmits a configuration of the common DL tunnel to the CN. The configuration can include transport-layer information such as an Internet Protocol (IP) address and a tunnel identifier (e.g., a Tunnel Endpoint Identifier (TEID)).

The base station can also configure one or more logical channels toward the UEs, and/or one or more MBS radio bearers (MRBs) associated with the MBS session, where there may be a one-to-one mapping between each logical channel and each MRB. After receiving MBS data for the MBS session via the common DL tunnel, the base station can transmit the MBS data via the one or more logical channels to one or more UEs that have joined the MBS session. In some implementations, the base station transmits MBS data to multiple UEs via a single logical channel. Further, if there are multiple quality-of-service (QOS) flows for the MBS session, a single logical channel may be associated with the multiple QoS flows, or there may be a one-to-one mapping between each QoS flow and each logical channel.

The CN can cause the base station to configure the common DL tunnel before or after a UE joins the MBS session. If additional UEs join the MBS session after the tunnel is configured, the CN can utilize the same common DL tunnel to transmit MBS data, for the multiple UEs, to the base station.

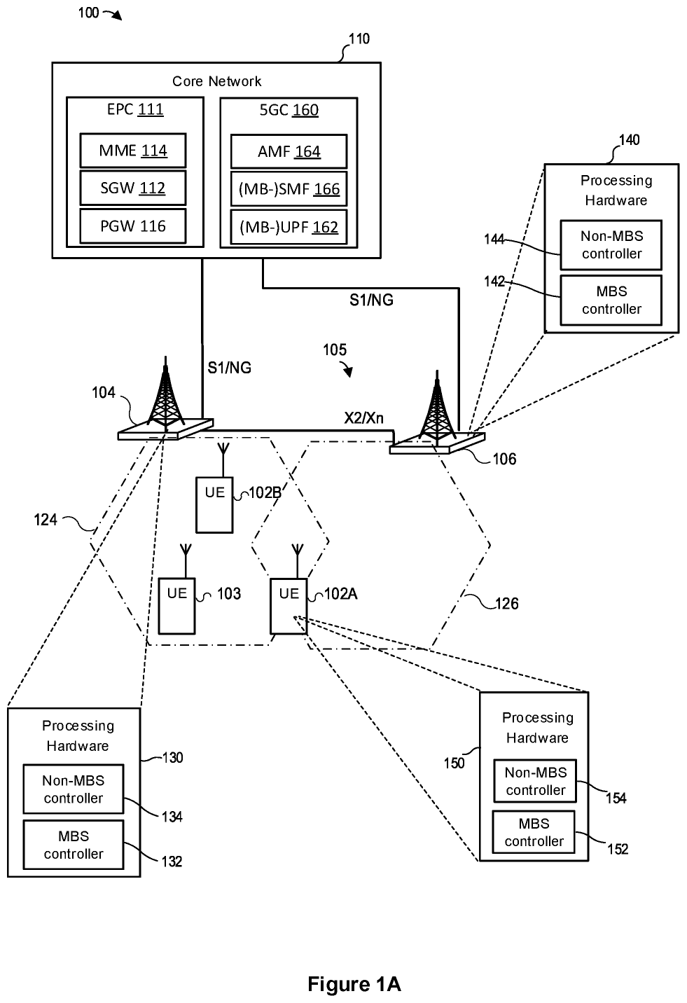

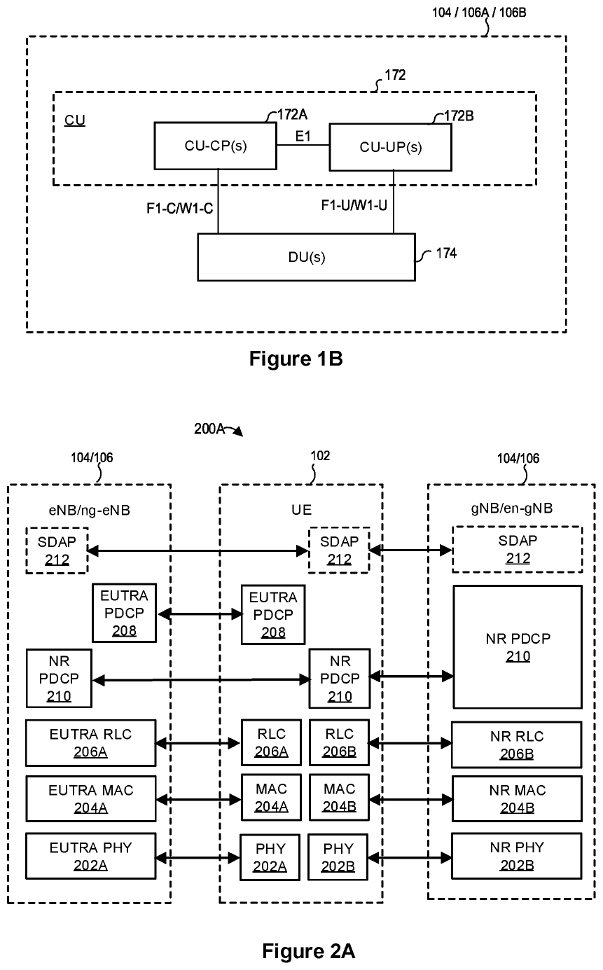

FIG. 1A depicts an example wireless communication system 100 in which techniques of this disclosure for managing transmission and reception of multicast and/or broadcast services (MBS) information can be implemented. The wireless communication system 100 includes user equipment (UEs) 102A, 102B, 103 as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base stations 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows the various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-NB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB)) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the UE MBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, the UE 102B may include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an SI interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an SI interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 includes a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of any one or more of the base stations 104 and 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

The description above can apply to the UEs 102B, 103A and 103B.

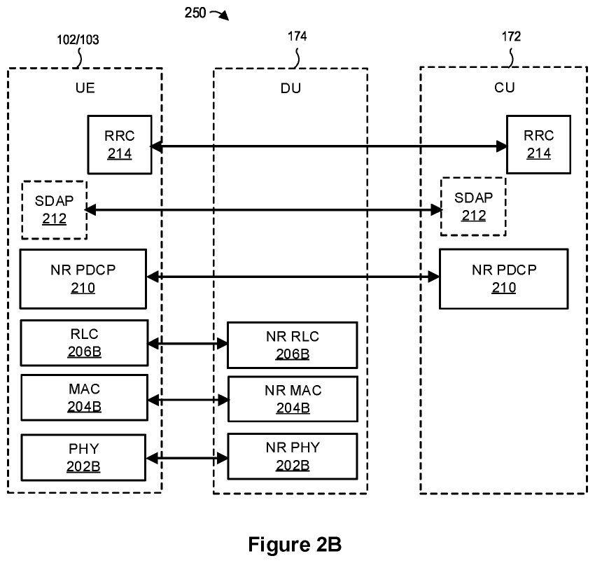

FIG. 2A illustrates, in a simplified manner, an example protocol stack 200 according to which a UE (e.g., UE 102A, 102B or 103) can communicate with an eNB/ng-eNB or a gNB (e.g., one or more of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE operates in EN-DC with the base station 104 operating as an MeNB and the base station 106 operating as an SgNB, the wireless communication system 100 can provide the UE with an MN-terminated bearer that uses EUTRA PDCP sublayer 208, or an MN-terminated bearer that uses NR PDCP sublayer 210. The wireless communication system 100 in various scenarios can also provide the UE with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts or multicasts MBS data packets via one or more MBS radio bearers (MRB(s)), and in turn the receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE uses PHY sublayer 202, MAC sublayer 204, and RLC sublayer 206 to receive the MBS data packets. In such implementations, the base station and the UE might or might not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE uses PHY sublayer 202, MAC sublayer 204, RLC sublayer 206 and PDCP sublayer 208 to receive the MBS data packets. In such implementations, the base station and the UE might or might not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 which the UE can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

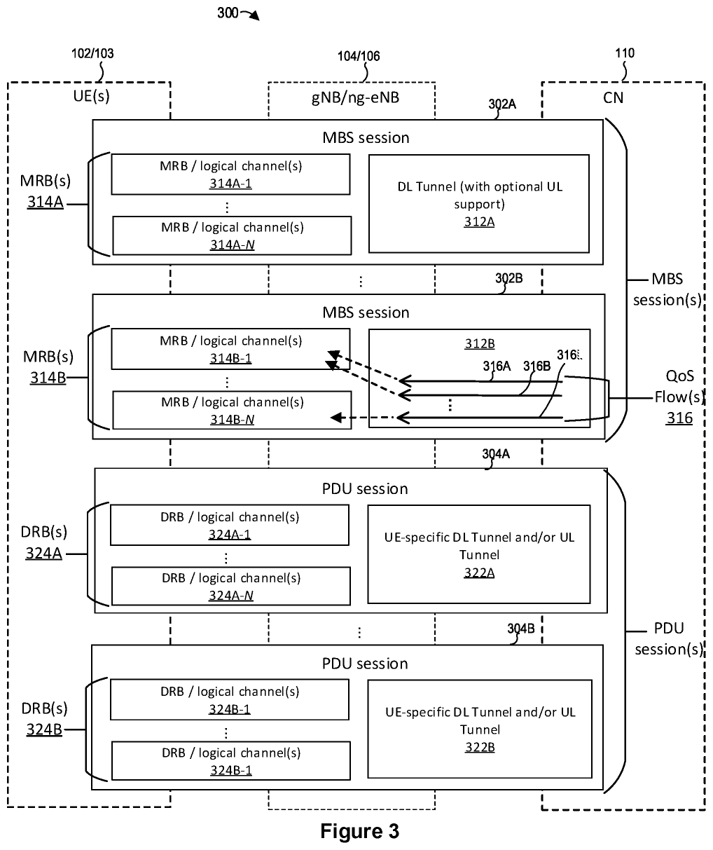

Referring to FIG. 3, an MBS session 302A can include a tunnel 312A with endpoints at the CN 110 and the base station 104/106. The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, CN 110 and the base station 104/106 use the tunnel 312A for downlink as well as for uplink (UL) MBS traffic to support, for example, commands or service requests from the UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet and transmit the tunnel packet downstream to the base station 104/106 via the tunnel 312A. The header(s) can include the IP address and/or the TEID. For example, the header(s) includes an IP header and an GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QOS) flows, for each of the tunnels 312A, 312B, etc. For example, the MBS traffic on the tunnel 312B can include a set of flows 316 including QoS flows 316A, 316B, . . . 316L. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific DL tunnel 322A corresponding to one or more DRBs 324A, such as a DRB 324A-1, 324A-2, . . . 324-N. Each of the DRBs 324A can correspond to a respective logical channel, such as a Dedicated Traffic Channel (DTCH).

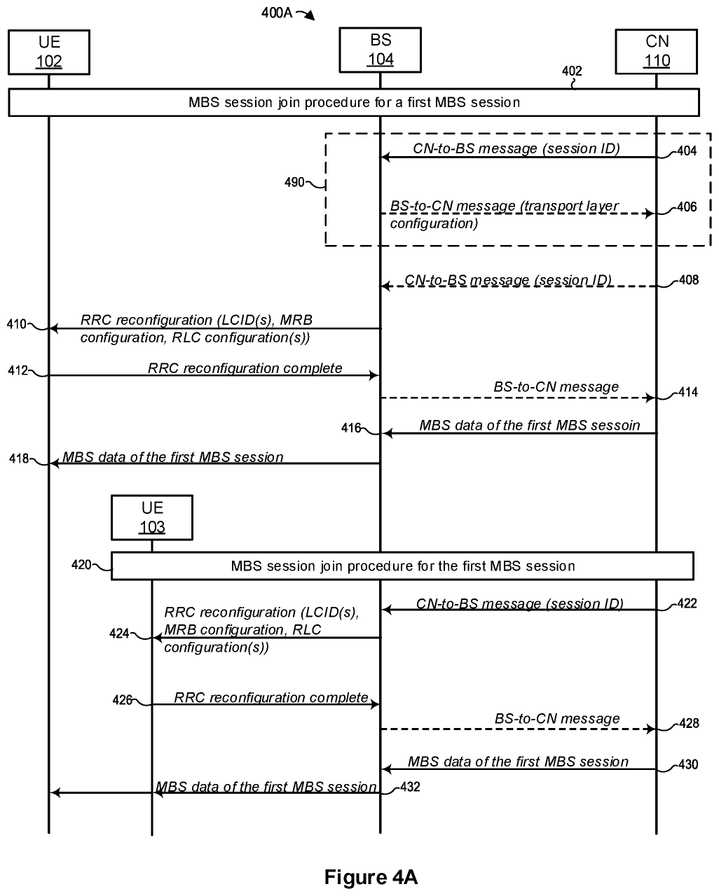

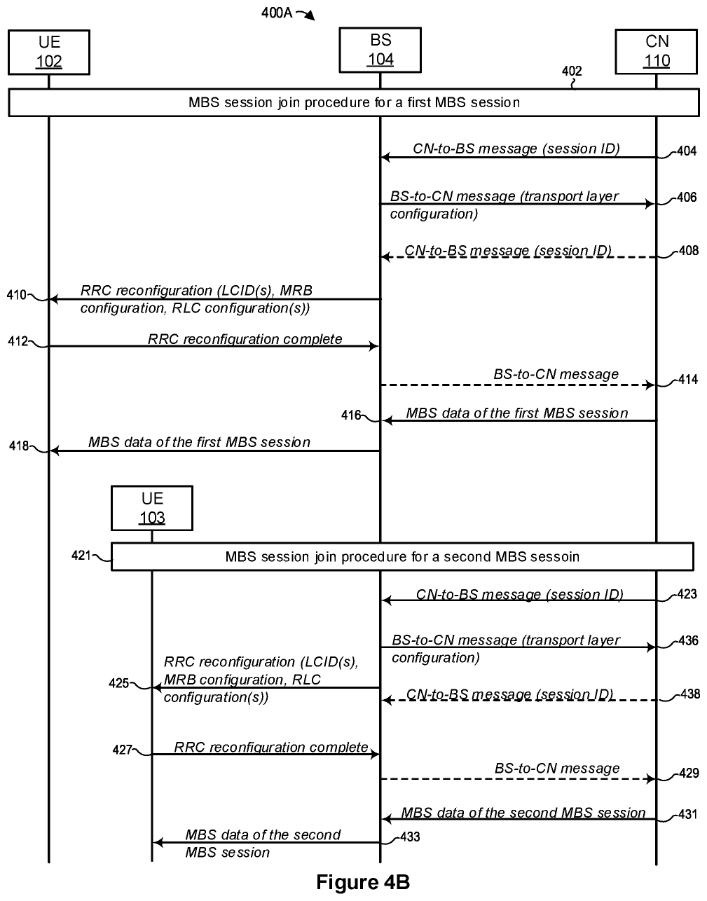

Next, FIG. 4A illustrates an example scenario 400A in which the base station 104 configures a common tunnel for MBS data in response to the CN requesting resources for an MBS session. In the following description, the UE 102 can represent the UE 102A and/or the UE 102B.

The UE 102 initially performs 402 an MBS session join procedure with the CN 110 via the base station 104 to join a certain MBS session. In some scenarios, the UE 102 subsequently performs additional one or more MBS join procedures, and event 402 accordingly is a first one of multiple MBS join procedures. To perform the MBS session join procedure, the UE 102 in some implementations sends an MBS session join request message to the CN 110 via the base station 104. In response, the CN 110 can send an MBS session join response message to the UE 102 via the base station 104 to grant the UE 102 access to the first MBS session. In some implementations, the UE 102 can include a (first) MBS session ID of the MBS session in the MBS session join request message. The CN 110 in some cases includes the MBS session ID in the MBS session join response message. In some implementations, the UE 102 can send an MBS session join complete message to the CN 110 via the base station 104 in response to the MBS session join response message.

The UE 102 in some cases performs additional MBS session join procedure(s) with the CN 110 via the RAN 105 (e.g., the base station 104 or base station 106) to join additional MBS session(s). For example, the UE 102 can perform a second MBS session join procedure with the CN 110 via the RAN 105 to join a second MBS session. Similar to event 402, the UE 102 in some implementations can send a second MBS session join request message to the CN 110 via the base station 104, and the CN 110 can respond with a second MBS session join response message to grant the UE 102 access to the second MBS session. In some implementations, the UE 102 can send a second MBS session join complete message to the CN 110 via the base station 104 in response to the second MBS session join response message. In some implementations, the UE 102 can include a second MBS session ID of the second MBS session in the second MBS session join request message. The CN 110 optionally includes the second MBS session ID in the second MBS session join response message. In some implementations, the UE 102 can include the first and second MBS session IDs in an MBS session join request message (e.g., the first MBS session join request message) to join the first and second MBS sessions at the same time. In such cases, the CN 110 can send an MBS session response message to grant either the first MBS session or the second MBS session, or both the first and MBS sessions.

In some implementations, the MBS session join request message, MBS session join response message, and MBS session join complete message can be session initiation protocol (SIP) messages. In other implementations, the MBS session join request message, MBS session join response message, and MBS session join complete message can be NAS messages such as 5G mobility management (5GMM) messages or 5G session management messages (5GSM). In the case of the 5GSM messages, the UE 102 can transmit to the CN 110 via the base station 104 a (first) UL container message including the MBS session join request message, the CN 110 can transmit to the UE 102 via the base station 104 a DL container message including the MBS session join response message, and the UE 102 can transmit to the CN 110 via the base station 104 a (second) UL container message including the MBS session join complete message. These container messages can be 5GMM messages. In some implementations, the MBS session join request message, MBS session join response message, and MBS session join complete message can be a PDU Session Modification Request message, a PDU Session Modification Command message, and a PDU Session Modification Complete message, respectively. To simplify the following description, the MBS session join request message, the MBS session join response message, and/or the MBS session join complete message can represent the container messages.

In some implementations, the UE 102 can perform a PDU session establishment procedure with the CN 110 via the base station 104 to establish a PDU session in order to perform the first MBS session join procedure and/or additional MBS session join procedure(s). During the PDU session establishment procedure, the UE 102 can communicate a PDU session ID of the PDU session with the CN 110 via the base station 104. During the first MBS session join procedure and/or additional MBS session join procedure(s), the UE 102 can communicate the PDU session ID with the CN 110 via the base station 104. For example, the UE 102 can include the PDU session ID in the MBS session join request message or the MBS session join complete message, and/or the CN 110 can include the PDU session ID in the MBS session join accept message. In some implementations, the PDU session IDs of the UE 102A and UE 102B can be the same (value). In other implementations, the PDU session IDs of the UE 102A and UE 102B can be the different (values).

Before, during, or after the (first) MBS session join procedure (event 402), the CN 110 can send 404 a (first) CN-to-BS message including the first MBS session ID and/or the PDU session ID to the base station 104 to request the base station 104 to configure resources for the first MBS session. The CN 110 can additionally include, in the CN-to-BS message, quality of service (QOS) configuration(s) for the first MBS session. In response, the base station 104 can (determine to) send 406 a (first) BS-to-CN message including a DL transport layer configuration to configure a common DL tunnel for the CN 110 to send MBS data to the base station 104. The DL transport layer configuration includes a transport layer address (e.g., an IP address) and/or a TEID to identify the common DL tunnel. The base station 104 can include the first MBS session ID and/or the PDU session ID in the BS-to-CN message. In cases where the base station 104 has configured a common DL tunnel has for the first MBS session before receiving the first BS-to-CN message, the base station 104 determines not send the BS-to-CN message. That is, the base station 104 refrains from sending the BS-to-CN message.

In some implementations, the CN-to-BS message of event 404 can be a generic NGAP message or a dedicated NGAP message defined specifically for requesting resources for an MBS session (e.g., MBS Session Resource Setup Request message). In some implementations, the BS-to-CN message of event 406 is a generic NGAP message or a dedicated NGAP message defined specifically to convey resources for an MBS session (e.g., MBS Session Resource Setup Response message). In such cases, the CN-to-BS message of event 404 and the BS-to-CN message of event 406 can be non-UE-specific messages and collectively referred to in FIG. 4A as an MBS resource setup procedure 490.

In some implementations, the CN 110 can indicate, in the CN-to-BS message of event 404, a list of UEs joining the first MBS session. In other implementations, the CN 110 can send 408 to the base station 104 a second CN-to-BS message indicating a list of UEs joining the first MBS session. The CN 110 can include the first MBS session ID and/or the PDU session ID in the second CN-to-BS message. The base station 104 can send 414 a second BS-to-CN message to the CN 110 in response to the second CN-to-BS message 408. In such cases, the second CN-to-BS message and the second BS-to-CN message can be non-UE-specific messages. For example, the list of UEs includes the UE 102A and/or UE 102B. To indicate a list of UEs, the CN 110 can include a list of (CN UE interface ID, RAN UE interface ID) pairs, each identifying a particular UE of the UEs. For example, the list of pairs includes a first pair of (a first CN UE interface ID and a first RAN UE interface ID) identifying the UE 102A and a second pair of (a second CN UE interface ID, a second RAN UE interface ID) identifying the UE 102B. In some implementations, the “CN UE interface ID” can be a “AMF UE NGAP ID” and the “RAN UE interface ID” can be a “RAN UE NGAP ID.” In other implementations, the CN 110 can include a list of UE IDs, each identifying a particular UE in the set of UEs. In some implementations, the CN 110 can assign the UE IDs and send each of the UE IDs to a particular UE of the UEs in a NAS procedure (e.g., registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs).

In some alternative implementations, the CN 110 can send 408 to the base station 104 another, second CN-to-BS message indicating that the UE 102 (e.g., a single UE such as UE 102A or UE 102B) joins the first MBS session. The base station 104 can send 414 another, second BS-to-CN message to the CN 110 in response to the second CN-to-BS message 408. In such cases, the CN 110 can include the MBS session join response message for the UE 102 in the second CN-to-BS message. The base station 104 can include a first CN UE interface ID and a first RAN UE interface ID, identifying the UE 102, in the second CN-to-BS message. In some implementations, the second CN-to-BS message and the second BS-to-CN message can be UE-specific NGAP messages, such as a PDU Session Resource Modify Request message and a PDU Session Resource Modify Response message, respectively.

In other implementations, the first CN-to-BS message can be a UE-specific NGAP message (e.g., PDU Session Resource Modify Request message) indicating that the UE 102 (e.g., a single UE such as UE 102A or UE 102B) joins the first MBS session. The CN 110 can include the MBS session join response message for the UE 102 in the first CN-to-BS message. The base station 104 can include a first CN UE interface ID and a first RAN UE interface ID, identifying the UE 102, in the first CN-to-BS message. In some implementations, the first BS-to-CN message can be a generic NGAP message or a dedicated NGAP message defined specifically to convey resources for an MBS session (e.g., MBS Session Resource Setup Indication message or RAN Configuration Update message). In such cases, the CN 110 can send 408 another, second CN-to-BS message (e.g., MBS Session Resource Setup Confirm message or RAN Configuration Update Acknowledge message) to the base station 104 in response to the first BS-to-CN message. The bae station 104 can send 414 to the CN 110 a second BS-to-CN message (e.g., PDU Session Resource Modify Response message) in response to the first CN-to-BS message.

In some implementations, the CN 110 can include the MBS session join response message for the UE 102 in another CN-to-BS message instead of the first CN-to-BS message or the second CN-to-BS message.

In some implementations, the QoS configuration(s) include QoS parameters for the MBS session. In some implementations, the QoS configuration includes configuration parameters to configure one or more QoS flows for the MBS session (see FIG. 3). In some implementations, the configuration parameters include one or more QoS flow IDs identifying the QoS flow(s). Each of the QoS flow ID(s) identifies a particular QoS flow of the Qos flow(s). In some implementations, the configuration parameters include QoS parameters for each QoS flow. The QoS parameters can include a 5G QoS identifier (5QI), a priority level, packet delay budget, packet error rate, averaging window, and/or a maximum data burst volume. The CN 110 can specify different values of the QoS parameters for the QoS flows.

In cases where the CN 110 grants the additional MBS session(s) for the UE 102 in the additional MBS session join procedure(s), the CN 110 can include the additional MBS session ID(s) and, optionally, QoS configuration(s) for the additional MBS session ID(s) in the first CN-to-BS message or the second CN-to-BS message. In such cases, the base station 104 includes additional transport layer configuration(s) for the additional MBS session(s) to configure additional common DL tunnel(s) in the first BS-to-CN message or the second CN-to-BS message. Each of the transport layer configuration(s) configures a particular common DL tunnel of the common DL tunnel(s) and can be associated to a particular MBS session of the additional MBS session(s). Alternatively, the CN 110 can perform additional MBS session resource setup procedure(s) with the base station 104 to obtain the additional transport layer configuration(s) from the base station 104, similar to the MBS resource setup procedure 490 shown in FIG. 4. The transport layer configurations can be different to distinguish between different common DL tunnels. In particular, any pair of the transport layer configurations can have different IP addresses, different DL TEIDs, or different IP addresses as well as different DL TEIDs.

In cases where the base station 104 establishes the common DL tunnel for the first MBS session as described above, the base station 104 may refrain from including a DL transport layer configuration for the first MBS session in the second BS-to-CN message. In such cases, the CN 110 may refrain from including a UL transport layer configuration for the first MBS session in the first CN-to-BS message and/or second CN-to-BS message.

After or in response to receiving 404 the first CN-to-BS message or 408 the second CN-to-BS message or transmitting 406 the first BS-to-CN message, the base station 104 generates RRC reconfiguration message(s) (e.g., RRCReconfiguration message(s)) including configuration parameters for the UE 102 to receive MBS data of the first MBS session. The base station 104 then transmits 410 the RRC reconfiguration message(s) to the UE 102. In response, the UE 102 transmits 412 an RRC reconfiguration complete message(s) (e.g., RRCReconfigurationComplete message(s)) to the base station 104. The base station 104 can send 414 the second BS-to-CN message to the CN 110 before or after receiving the RRC reconfiguration complete message(s).

After receiving 406 the first BS-to-CN message or receiving 414 the second BS-to-CN message, the CN 110 can send 416 MBS data to the base station 104, which in turn transmits (e.g., multicast or unicast) 418 the MBS data via the one or more logical channels to the UE 102. The UE 102 receives 418 the MBS data via the one or more logical channels. For example, the base station 104 receives 416 an MBS data packet, generates a PDCP PDU including the MBS data packet, generates a MAC PDU including the logical channel ID and the PDCP PDU, and transmits 418 the MAC PDU to the UE 102. The UE 102 receives 418 the MAC PDU, retrieves the PDCP PDU and the logical channel ID from the MAC PDU, identifies the PDCP PDU associated with the MRB and retrieves the MBS data packet from the PDCP PDU.

In some implementations, the configuration parameters can include one or more MRB configurations configuring one or more MRBs associated with the first MBS session. The configuration parameters can also include one or more RLC bearer configurations, each associated with a particular MRB. Each of the MRB configuration(s) can include an MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel. In some implementations, the configuration parameters or the MRB configuration may include logical channel configuration (e.g., LogicalChannelConfig IE) configuring configure the logical channel. In some implementations, the RLC bearer configuration may include the MRB ID.

In some implementations, the base station 104 can configure the MRB as a DL-only RB in the MRB configuration. For example, the base station 104 can refrain from including UL configuration parameters in the PDCP configuration within the MRB configuration to configure the MRB as a DL-only RB. The base station 104 can include only DL configuration parameters in the MRB configuration, e.g., as described above. In such cases, the base station 104 configures the UE 102 to not transmit UL PDCP data PDU via the MRB to the base station 104 by excluding the UL configuration parameters for the MRB in the PDCP configuration in the MRB configuration. In another example, the base station 104 refrains from including UL configuration parameters in the RLC bearer configuration. In such cases, the base station 104 configures the UE 102 not to transmit the control PDU(s) via the logical channel to the base station 104 by excluding the UL configuration parameters from the RLC bearer configuration.

In cases where the base station 104 includes UL configuration parameter(s) in the RLC bearer configuration, the UE 102 may transmit control PDU(s) (e.g., PDCP Control PDU(s) and/or RLC Control PDU(s)) via the logical channel to the base station 104 using the UL configuration parameter(s). For example, the base station 104 may configure the UE to receive MBS data with a (de) compression protocol (e.g., robust header compression (ROHC) protocol). In this case, when the base station 104 receives 416 an MBS data packet from the CN 110, the base station 104 compresses the MBS data packet with the compression protocol to obtain compressed MBS data packet(s) and transmits 418 a PDCP PDU including the compressed MBS data packet to the UE 102. When the UE 102 receives the compressed MBS data packet(s), the UE 102 decompresses the compressed MBS data packet(s) with the (de) compression protocol to obtain the original MBS data packet. In such cases, the UE 102 may transmit a PDCP Control PDU including, a header compression protocol feedback (e.g., interspersed ROHC feedback) for operation of the header (de) compression protocol, via the logical channel to the base station 104.

In some implementations, the MRB configuration can be an MRB-ToAddMod IE including an MRB ID (e.g., mrb-Identity or MRB-Identity). An MRB ID identifies a particular MRB of the MRB(s). The base station 104 sets the MRB IDs to different values. In cases where the base station 104 has configured DRB(s) to the UE 102 for unicast data communication, the base station 104 in some implementations can set the MRB ID(s) to values different from DRB ID(s) of the DRB(s). In such cases, the UE 102 and the base station 104 can distinguish whether an RB is an MRB or a DRB in accordance an RB ID of the RB. In other implementations, the base station 104 can set one or more of the MRB ID(s) to values which can be the same as one or more of the DRB ID(s). In such cases, the UE 102 and the base station 104 can distinguish whether an RB is an MRB or a DRB in accordance an RB ID of the RB and an RRC IE configuring the RB. For example, a DRB configuration configuring a DRB is a DRB-ToAddMod IE including a DRB identity (e.g., drb-Identity or DRB-Identity) and a PDCP configuration. Thus, the UE 102 and base station 104 can determine an RB is a DRB if the UE 102 receives a DRB-ToAddMod IE configuring the RB, and determine an RB is an MRB if the UE 102 receives an MRB-ToAddMod IE configuring the RB.

In some implementations, the configuration parameters for receiving MBS data of the first MBS session include one or more logical channel (LC) IDs to configure one or more logical channels. In some implementations, the logical channel(s) can be dedicated traffic channel(s) (DTCH(s)). In other implementations, the logical channel(s) can be multicast traffic channel(s) (MTCH(s)). In some implementations, the configuration parameters might or might not include a group radio network temporary identifier (G-RNTI). The RRC reconfiguration messages for UEs (e.g., the UE 102A and the UE 102B) joining the first MBS session, include the same configuration parameters for receiving MBS data of the first MBS session. In some implementations, the RRC reconfiguration messages for the UEs may include the same or different configuration parameters for receiving non-MBS data.

In some implementations, the base station 104 can include the MBS session join response message in the RRC reconfiguration message the base station 104 transmits 410 to the UE 102. The UE 102 can include the MBS session join complete message in the RRC reconfiguration complete message of event 412. Alternatively, the UE 102 can send a UL RRC message including the MBS session join complete message to the base station 104. The UL RRC message can be a ULInformationTransfer message or any suitable RRC message that can include a UL NAS PDU. The base station 104 can include the MBS session join complete message in the second BS-to-CN message. Alternatively, the base station 104 can send the CN 110 a BS-to-CN message (e.g., an UPLINK NAS TRANSPORT message) including the MBS session join complete r message to the CN 110.

In other implementations, the base station 104 transmits a DL RRC message that includes the MBS session join response message to the UE 102. The DL RRC message can be a DLInformation Transfer message, another RRC reconfiguration message, or any suitable RRC message that can include a DL NAS PDU. The UE 102 can send a UL RRC message including the MBS session join complete message to the base station 104. The UL RRC message can be a ULInformationTransfer message, another RRC reconfiguration complete message or any suitable RRC message that can include a UL NAS PDU.

With continued reference to FIG. 4A, the UE 103 can perform 420 an MBS session join procedure similar to the procedure 402 discussed above. The UE 103 can perform a PDU session establishment procedure with the CN 110 via the base station 104 as described above. The UE 103 can communicate a PDU session ID with the CN 110 in the PDU session establishment procedure. The UE 103 can join the same MBS session as the UE 102 by sending an MBS session join request and specifying the same MBS session ID. In this example scenario, the UE 103 joins the MBS session after the base station 104 has started transmitting 418 MBS data packets to the UE 102. The CN 110 transmits 422, to the base station 104, a CN-to-BS message including the MBS session ID and/or the PDU session ID in order to indicate that the UE 103 joins the MBS session, similar to event 404. In some implementations, the PDU session IDs of the UE 102 and UE 103 can be the same (value). In other implementations, the PDU session IDs of the UE 102 and UE 103 can be the different (values).

The base station 104 or CN 110 determines that a DL tunnel for the MBS session identified in the event 422 already exists, and that there is no need to perform the procedure 490. The base station 104 transmits 424 an RRC reconfiguration message to the UE 103 to configure the UE 103 to receive the MBS traffic. The RRC reconfiguration message can include the same LCID (value), MRB configuration, and RLC bearer configuration as the event 410, when the UEs 102 and 103 operate in the same cell. When the UEs 102 and 103 operate in different cells, the RRC reconfiguration message can have a different, G-RNTI, LCID and/or RLC bearer configuration, for example. The RRC reconfiguration message can include the same MRB configuration as the event 410, when the UEs 102 and 103 operate in different cells. As illustrated in FIG. 3, the base station 104 can map data packets arriving via the common DL tunnel to one or more MRBs, each corresponding to a respective logical channel.

The UE 103 transmits 426 an RRC reconfiguration complete message(s) (e.g., RRCReconfiguration Complete message(s)) to the base station 104 in response to the RRC reconfiguration message(s) of event 424. Before or after receiving 426 the RRC reconfiguration complete message(s), the base station 104 in some cases sends 428 another BS-to-CN message to the CN 110, generally similar to the event 414. The BS-to-CN message can indicate an updated list of UEs associated with the MBS session specified in the event 422, for example. After the UE 103 has joined 420 the MBS session and obtained 424 the necessary RRC configuration, the base station 104 continues to receive 430 MBS data via the common DL tunnel. In some implementations, the base station 104 transmits 432 the MBS data to the UE 102 and UE 103 via multicast. The UE 102 and UE 103 can receive 432 MBS data similar to event 418. Alternatively, the base station 104 can transmit the MBS data to the UE 102 and UE 103 separately via unicast.

Referring next to FIG. 4B, a scenario 400B is depicted which is generally similar to the scenario 400A. Events in this scenario similar to those discussed above are labeled with the same reference numbers and the examples and implementations for FIG. 4A can apply to FIG. 4B. The differences between the scenarios of FIG. 4A and FIG. 4B are discussed below.

The UE 103 can perform 422 an MBS session join procedure similar to the procedure 402 discussed above. To perform the MBS session join procedure, the UE 103 can perform a PDU session establishment procedure with the CN 110 via the base station 104 as described above. The UE 103 can communicate a PDU session ID with the CN 110 in the PDU session establishment procedure. The UE 103 can join a second MBS session by sending an MBS session join request and specifying a second MBS session ID. In this example scenario, the UE 103 joins the second MBS session before or after the base station 104 has started transmitting 418 MBS data packets to the UE 102. The CN 110 transmits 422, to the base station 104, a CN-to-BS message including the second MBS session ID and/or the PDU session ID in order to indicate that the UE 103 joins the second MBS session, similar to event 404. In some implementations, the PDU session IDs of the UE 102 and UE 103 can be the same (value). In other implementations, the PDU session IDs of the UE 102 and UE 103 can be the different (values).

The CN 110 sends 423 a CN-to-BS message including the second MBS session ID to the base station 104 to indicate that the UE 103 joins the second MBS session, similar to the event 404. The base station 104 determines that a (second) DL tunnel for the second MBS session does not exist, and sends 436 to the CN 110 a BS-to-CN message including a DL transport layer configuration to configure a common DL tunnel for the CN 110 to send MBS data to the base station 104, similar to the event 406. The DL transport layer configuration includes a transport layer address (e.g., an IP address and/or a TEID) to identify the common DL tunnel. The base station 104 can include the second MBS session ID and/or the PDU session ID of the UE 103 in the BS-to-CN message 423. In response, the CN 110 can send 438 a CN-to-BS message to the base station 104, similar to the event 408. The base station 104 can send 429 a BS-to-CN message to the CN 110 in response to the CN-to-BS message 423, similar to the event 414.

After or in response to receiving 423 or 438 the CN-to-BS message or transmitting 436 the BS-to-CN message, the base station 104 transmits 425 an RRC reconfiguration message to the UE 103 to configure the UE 103 to receive the MBS traffic, similar to the event 410. The RRC reconfiguration message can include a (second) G-RNTI, a (second) LCID (value), a (second) MRB configuration, and a (second) RLC bearer configuration different from the event 410, e.g., when the UEs 102 and 103 operate in the same cell. When the UEs 102 and 103 operate in different cells, the RRC reconfiguration message can have a different G-RNTI, LCID, RLC bearer configuration and/or MRB configuration, for example. In another example, when the UEs 102 and 103 operate in different cells, the RRC reconfiguration message can have the same G-RNTI, LCID, RLC bearer configuration and/or MRB configuration.

The UE 103 transmits 427 an RRC reconfiguration complete message(s) (e.g., RRCReconfigurationComplete message(s)) to the base station 104 in response to the RRC reconfiguration message(s) of event 425. Before or after receiving 427 the RRC reconfiguration complete message(s), the base station 104 in some cases sends 429 the BS-to-CN message to the CN 110, generally similar to the event 414. After the UE 103 has joined 421 the second MBS session and obtained 425 the necessary RRC configuration, the base station 104 receives 431 MBS data via the second common DL tunnel. In some implementations, the base station 104 transmits 433 the MBS data to the UE 103 via multicast or unicast, similar to event 418. The UE 103 can receive 433 MBS data similar to event 418. After the UE 103 joins the second MBS session, the base station 104 can continue to receive MBS data packets of the first MBS session from the CN 110 and transmits the MBS data packets to the UE 102, similar to the events 416 and 418.

As illustrated in FIG. 3, the base station 104 can map data packets of a particular MBS session via a particular common DL tunnel to one or more MRBs, each corresponding to a respective logical channel. As described above, the base station 104 at event 406 configures the first common DL tunnel, and the base station 104 at event 410 configures at least one first MRB (ID) for the first MBS session (ID) and configures at least one logical channel (ID) for (each of) the at least one first MRB (ID). As described above, the base station 104 at event 425 configures the second common DL tunnel, and the base station 104 at event 410 configures at least one second MRB (ID) for the second MBS session (ID) and configures at least one logical channel (ID) for (each of) the at least one second MRB (ID). The base station 104 can map data packets of the first MBS session via the first common DL tunnel (e.g., event 416) to at least one first logical channel (ID), and map data packets of the second MBS session via the second common DL tunnel (e.g., event 431) to at least one second logical channel (ID). Thus, the base station 104 transmits 418 at least one first MAC PDU, each including the at least one first logical channel ID and (a portion of) a particular MBS data packet of event 416, to the UE 102 via multicast or unicast. Similarly, the base station 104 transmits 433 at least one second MAC PDU, each including the at least one second logical channel ID and (a portion of) a particular MBS data packet of event 431, to the UE 103 via multicast or unicast.

In some implementations, the UE 103 can join both the first MBS session and the second MBS session as described for FIGS. 4A and 4B. In such cases, when the UE 103 receives a MAC PDU including a particular logical channel ID and an MBS data packet, the UE 103, the UE 103 can determine the MBS data packet associated with the first MRB(s) or the second MRB(s) in accordance with the logical channel ID. More specifically, if the logical channel ID is one of the first logical channel ID(s), the UE 103 determines the MBS data packet associated with the first MRB(s) (i.e., the first MBS session), and if the logical channel ID is one of the second logical channel ID(s), the UE 103 determines the MBS data packet associated with the second MRB(s) (i.e., the second MBS session).

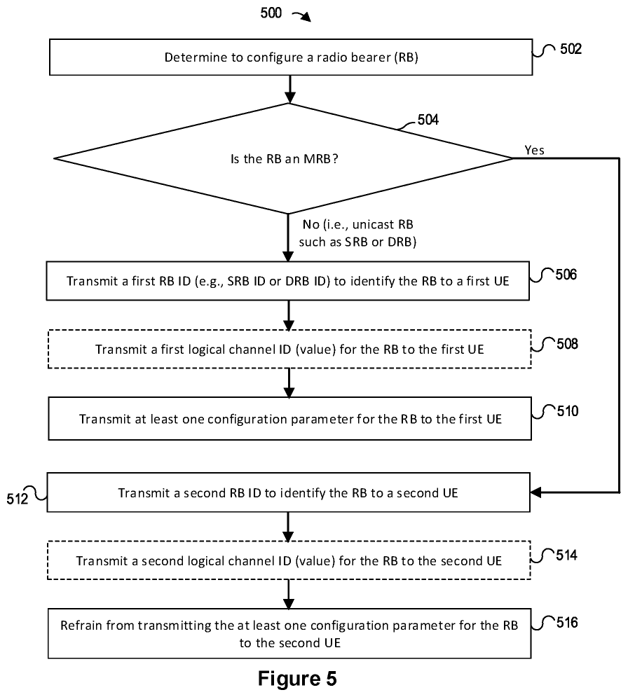

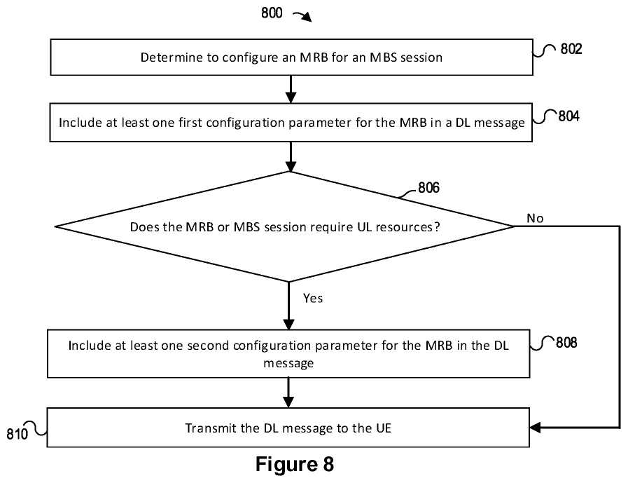

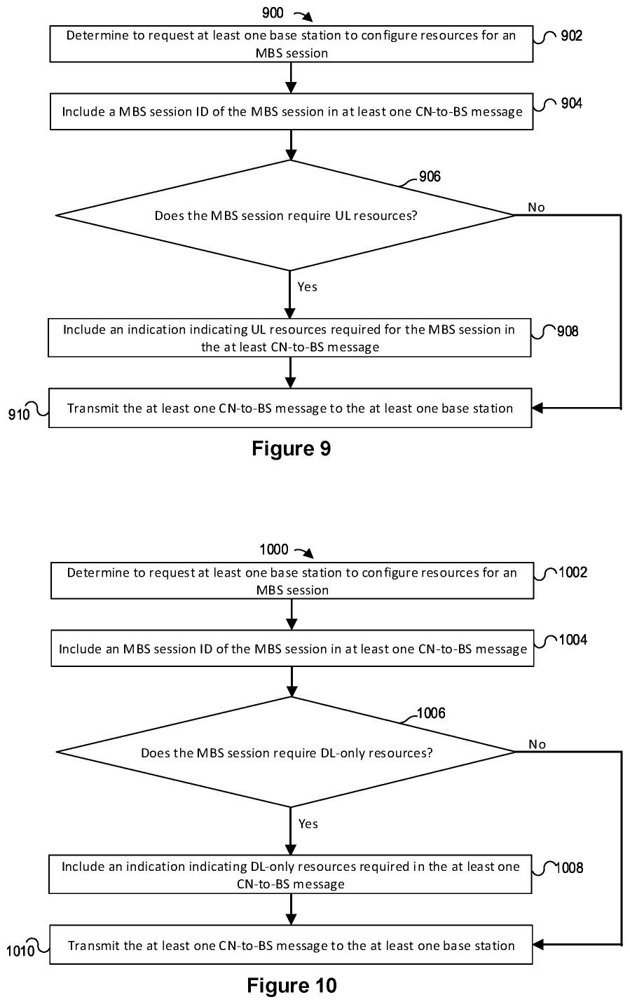

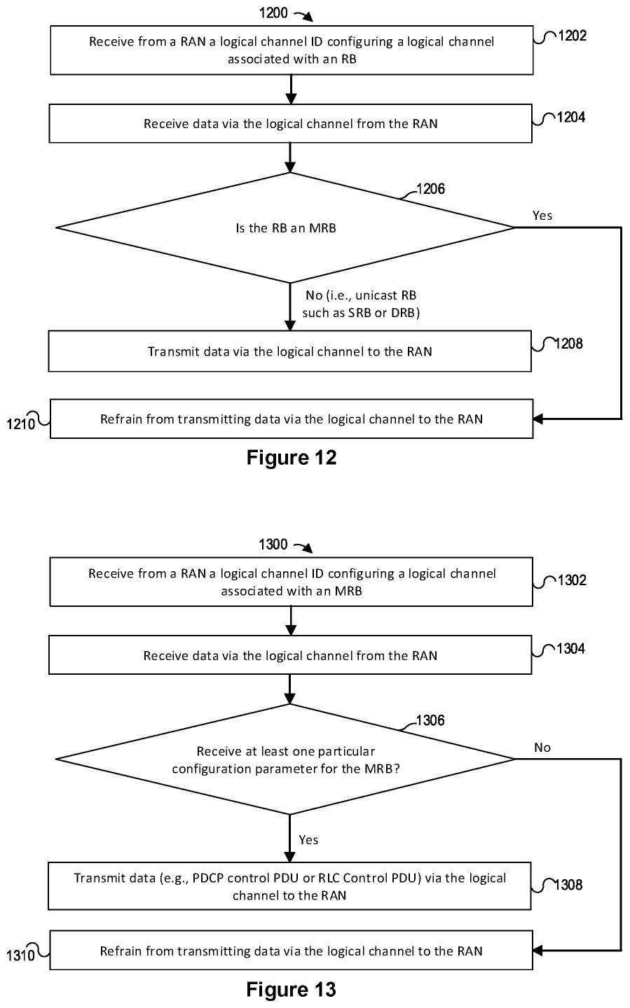

Next, several example methods which devices illustrated in FIGS. 1A and 1B can implement are discussed with reference to FIGS. 5-18. Each of these methods can be implemented as a set of instructions stored on a non-transitory computer-readable medium and executable by one or more processors. FIGS. 5-8, 11, and 14-15 illustrate methods that can be implemented by a base station, FIGS. 9-10 and 16 illustrate example methods that can be implemented by a CN, and FIGS. 12-13 and 17-18 illustrate methods that can be implemented by a UE.

Referring first to FIG. 5, a base station such as the base station 104 can implement a method 500 to determine whether to configure particular configuration parameter(s) for a radio bearer (RB) based on whether the RB is an MRB or a unicast RB. The method 500 begins at block 502, where the base station determines to configure an RB. At block 504, the base station determines whether the RB is an MRB. When the base station determines the RB is a unicast RB (e.g., SRB or DRB), the flow proceeds to block 506. At block 506, the base station transmits a first RB ID (e.g., SRB ID or DRB ID) to identify the RB to a first UE. At block 508, the base station transmits a first logical channel ID (value) for the RB to the first UE. At block 510, the base station transmits at least one configuration parameter for the RB to the first UE. Otherwise, when the base station determines the RB is an MRB, at block 504, the flow proceeds to block 512. At block 512, the base station transmits a second RB ID to identify the RB to a second UE (see, e.g., event 410, 424, 425). At block 514, the base station transmits a second logical channel ID (value) for the RB to the second UE (see, e.g., event 410, 424, 425). At block 516, the base station refrains from transmitting the at least one configuration parameter for the RB to the second UE. Examples of the at least one configuration parameter are described below.

In some implementations, the first and second UEs are the same UE. In other implementations, the first and second UEs are different UEs. In some implementations, the base station can transmit to the first UE at least one first message including the first RB ID, the first logical channel ID (value) and the at least one configuration parameter. In some implementations, the base station can transmit to the second UE at least one second message including the second RB ID and the second logical channel ID (value), and excluding the at least one configuration parameter. For example, the at least one first message and/or the at least one second message includes one or more RRC reconfiguration messages (e.g., RRCReconfiguration message(s)).

In some implementations, the at least one configuration parameter includes a logical channel configuration (e.g., mac-LogicalChannelConfig field or LogicalChannelConfig IE). In other implementations, the at least one configuration parameter includes uplink configuration parameters for a MAC layer (e.g., ul-SpecificParameters field). In yet other implementations, the at least one configuration parameter includes a logical channel group (e.g., logicalChannelGroup field), a subcarrier spacing list (e.g., allowedSCS-List field), a scheduling request ID (e.g., schedulingRequestedID field or SchedulingRequestedld IE), a timer value (e.g., bitRateQueryProhibitTimer), a physical priority index (e.g., allowedPHY-PriorityIndex), a channel access priority (e.g., channelAccessPriority) and/or a bitrate multiplier (e.g., a bitRateMultiplier).

In cases where the RB is a unicast RB, the base station can transmit at least one first uplink configuration parameter for a physical layer to the first UE, e.g., in the at least one first message. When the UE receives a PDSCH transmission including a PDU associated with the RB (i.e., unicast RB), the UE can transmit a HARQ feedback to the base station in accordance with the at least one first configuration parameter. For example, the at least one first configuration parameter can include a PUCCH configuration (e.g., PUCCH-Config IE). In another example, the at least one first configuration parameter can include at least one PUCCH resource configuration, which can include or configure one or more PUCCH resources (e.g., PUCCH-Resource IE(s)) and/or one or more PUCCH resource sets (e.g., one or more PUCCH-ResourceSet IEs)). In yet another example, the at least one first configuration parameter can include at least one PUCCH format configuration (e.g., PHCCH-FormatConfig IE(s)), at least one PUCCH spatial relation configuration (e.g., PUCCH-SpatialRelationInfo IE(s)), a PUCCH power control configuration (e.g., PUCCH-PowerControl IE), and/or at least one downlink data to uplink acknowledge timing configuration (e.g., dl-DataToUL-ACK field, dl-DataToUL-ACK-DCI-1-2 field, dl-DataToUL-ACK-r16 field, and/or dl-DataToUL-ACK-DCI-1-2-r17 field).

In cases where the RB is an MRB, the base station can transmit at least one second uplink configuration parameter for the physical layer to the second UE, e.g., in the at least one second message. When the UE receives a PDSCH transmission including a PDU associated with the MRB, the UE can transmit a HARQ feedback to the base station in accordance with the at least one second configuration parameter. For example, the at least one second configuration parameter can include a PUCCH configuration (e.g., PUCCH-Config IE). In another example, the at least one second configuration parameter can include at least one PUCCH resource configuration, which can include or configure one or more PUCCH resources (e.g., PUCCH-Resource IE(s)) and/or one or more PUCCH resource sets (e.g., one or more PUCCH-ResourceSet IEs)). In yet another example, the at least one second configuration parameter can include at least one PUCCH format configuration (e.g., PHCCH-FormatConfig IE(s)), at least one PUCCH spatial relation configuration (e.g., PUCCH-SpatialRelationInfo IE(s)), a PUCCH power control configuration (e.g., PUCCH-PowerControl IE), and/or at least one downlink data to uplink acknowledge timing configuration (e.g., dl-DataToUL-ACK field, dl-DataToUL-ACK-DCI-1-2 field, dl-DataToUL-ACK-r16 field, and/or dl-DataToUL-ACK-DCI-1-2-r17 field). In some implementations, the at least one first uplink configuration parameter for the physical layer and the at least one second uplink configuration parameter for the physical layer can include the same configuration parameter(s) (value(s)). In other implementations, the at least one first uplink configuration parameter for the physical layer and the at least one second uplink configuration parameter for the physical layer can include different configuration parameter(s) (value(s)).

In cases where the RB is an MRB, the base station can transmit a G-RNTI to the second UE, e.g., in the at least one second message. Thus, the second UE can use the G-RNTI to receive MBS data via the MRB.

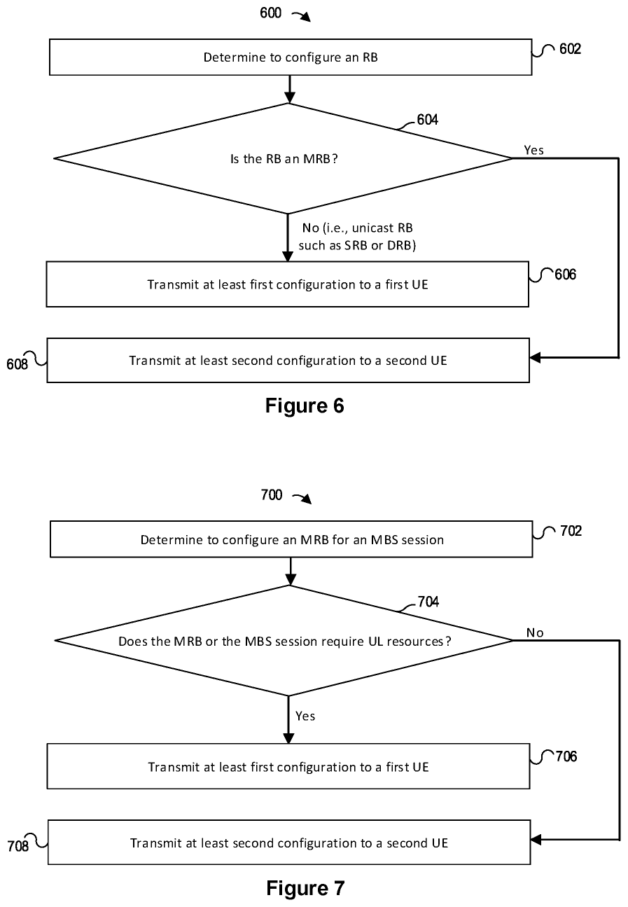

Referring next to FIG. 6, a base station such as the base station 104 can implement a method 600 to select a configuration for a RB based on whether the RB is an MRB or a unicast RB. The method 600 begins at block 602, where the base station determines to configure an RB. At block 604, the base station determines whether the RB is an MRB. When the base station determines the RB is not an MRB (i.e., unicast RB such as SRB or DRB), the flow proceeds to block 606. At block 606, the base station transmits at least one first configuration to a first UE. Otherwise, if the base station determines the RB is an MRB, the flow proceeds to block 608. At block 608, the base station transmits at least one second configuration to a second UE (see, e.g., event 410, 424, 425). Example differences between the first and second configurations are discussed below.

In some implementations, the first and second UEs are the same UE. In other implementations, the first and second UEs are different UEs. In some implementations, the base station can transmit to the first UE a first message including the first configuration(s). In some implementations, the base station can transmit to the second UE at least one second message including the second configuration(s). For example, the first message and/or second message can be RRC reconfiguration messages (e.g., RRCReconfiguration message).

In some implementations, the first configuration(s) and the second configuration(s) can be or include a first cell group configuration (e.g., CellGroupConfig IE) and a second cell group configuration (e.g., CellGroupConfig IE), respectively. The first cell group configuration and the second cell group configurations can include a first RLC bearer configuration (e.g., RLC-BearerConfig IE) and a second RLC bearer configuration (e.g., RLC-BearerConfig IE), respectively. In other implementations, the first and second configurations can be or include the first RLC bearer configuration (e.g., RLC-BearerConfig IE) and the second cell group configuration (e.g., RLC-BearerConfig IE), respectively. In some implementations, the base station configures RLC acknowledged mode in the first RLC bearer configuration. In such cases, the base station includes the at least one configuration parameter (described above with reference to FIG. 5) in the first RLC bearer configuration. In some implementations, the base station configures RLC unacknowledged mode for DL only in the second RLC bearer configuration. In such cases, the base station refrains from including the at least one configuration parameter (described above with reference to FIG. 5) in the second RLC bearer configuration.

In some implementations, the first configuration(s) and the second configuration(s) can include a unicast RB configuration and an MRB configuration (e.g., MRB-ToAddMod IE), respectively. For example, the unicast RB configuration can be a DRB configuration (e.g., DRB-ToAddMod IE) or SRB configuration (e.g., SRB-ToAddMod IE). In some implementations, the first cell group configuration and the DRB configuration can include a DRB ID, and the second cell group configuration and the MRB configuration can include an MRB ID. Depending on the implementation, the base station can set the DRB ID and the MRB ID to the same value or different values.

In some implementations, the base station can include the at least one first uplink configuration parameter (described above with reference to FIG. 5) for the physical layer in the first configuration(s). Similarly, the base station can include the at least one second uplink configuration parameter for the physical layer (described above with reference to FIG. 5) in the second configuration(s). In some implementations, the base station can include a G-RNTI in the second configuration(s) and refrain from including a G-RNTI in the first configuration(s).

Now referring to FIG. 7, a base station such as the base station 104 can implement a method 700 to determine to configure a an MRB associated with an MBS session based on whether the MRB or MBS session requires uplink (UL) resources. The method 700 begins at block 702, where the base station determines to configure an MRB for an MBS session. At block 704, the base station determines whether the MRB or the MBS session requires UL resources. When the base station determines the MRB or the MBS session requires UL resources, the flow proceeds to block 706. At block 706, the base station transmits at least one first configuration to a first UE (see, e.g., event 410, 424, 425). Otherwise, when the base station determines the MRB or the MBS session does not require UL resources, the flow proceeds to block 708. At block 708, the base station transmits at least one second configuration to a second UE (see, e.g., event 410, 424, 425). The at least one first configuration and the at least one second configuration can be the at least one first configuration and the at least one second configuration, respectively, described above with reference to FIG. 6.

In some implementations, the base station determines whether the MBS session requires UL resources in accordance with QoS parameter(s) associated with the MBS session. In some implementations, the base station receives at least one CN-to-BS message including the QoS parameter(s) from a CN. In other implementations, the base station is preconfigured with the QoS parameter(s).

In one implementation, if the QoS parameter(s) include particular QoS parameter(s) (e.g., first QoS parameter(s)), the base station determines that the MBS session requires UL resources. Otherwise (e.g., if the QoS parameter(s) does not include particular QoS parameter(s)), the base station determines that the MBS session does not require UL resources. For example, the QoS parameter(s) include a QoS flow ID. In such an example, if the QoS flow ID is a particular QoS flow ID (e.g., a first QoS flow ID), the base station determines that the MBS session requires UL resources. Otherwise (e.g., if the QoS flow ID is not the particular QoS flow ID), the base station determines that the MBS session does not require UL resources. In another example, the QoS parameter(s) include QoS flow level Qos parameters. In such an example, if the QoS flow level QoS parameters include particular QoS flow level QoS parameters (e.g., first QoS flow level QoS parameters), the base station determines that the MBS session requires UL resources. Otherwise (e.g., if the QoS flow level QoS parameters does not include the particular QoS flow level QoS parameters), the base station determines that the MBS session does not require UL resources. In another implementation, if the QoS parameter(s) include a QoS parameter for uplink, the base station determines that the MBS session requires UL resources. Otherwise (e.g., if the QoS parameter(s) does not include a QoS parameter for uplink), the base station determines that the MBS session does not require UL resources. For example, if the QoS parameter(s) includes a UE aggregate maximum bit rate for uplink, the base station determines that the MBS session requires UL resources. Otherwise (e.g., if QoS parameter(s) does not include a UE aggregate maximum bit rate for uplink), the base station determines that the MBS session does not require UL resources.

In some implementations, the base station receives from a CN a CN-to-BS message for the MBS session. If the CN-to-BS message includes an indication indicating UL resources required, the base station determines the MBS session requires UL resources. Otherwise (e.g., if the CN-to-BS message does not include an indication indicating UL resources required for the MBS session or includes an indication indicating DL-only resources required for the MBS session), the base station determines the MBS session does not require UL resources.

Referring next to FIG. 8, a base station such as the base station 104 can implement a method 800 to determine whether to configure particular configuration parameter(s) for an MRB associated with an MBS session, based on whether the MRB or MBS session requires uplink (UL) resources.

The method 800 begins at block 802, where the base station determines to configure an MRB for an MBS session. At block 804, the base station includes at least one first configuration parameter for the MRB in a DL message. At block 806, the base station determines whether the MRB or MBS session requires UL resources. When the base station determines the MRB or MBS session requires UL resources, the flow proceeds to block 808, and from block 808 to block 810. At block 808, the base station includes at least one second configuration parameter for the MRB in the DL message (see, e.g., event 410, 424, 425). Otherwise, when the base station determines the MRB or MBS session does not require UL resources, the flow proceeds from block 806 to block 810. At block 810, the base station transmits the DL message to the UE (see, e.g., event 410, 424, 425).

In some implementations, the at least one second configuration parameter for the MRB is the at least one configuration parameter described above for FIG. 5. In some implementations, the DL message can be an RRC reconfiguration message. The UE operating in a connected state (RRC_CONNECTED) receives the DL message.

Next, FIG. 9 illustrates an example method 900 for determining whether to indicate, in a CN-to-BS message, that uplink (UL) resources are required for an MBS session, which can be implemented in a suitable CN node (e.g., AMF 164). The method 900 begins at block 902, where the CN node determines to request at least one base station to configure resources for an MBS session. At block 904, the CN node includes an MBS session ID of the MBS session in at least one CN-to-BS message (see, e.g., events 404, 408, 423, 438). At block 906, the CN node determines whether the MBS session requires UL resources. When the CN node determines the MBS session requires UL resources, the flow proceeds to block 908, and from block 908 to block 910. At block 908, the CN node includes an indication indicating UL resources required in (each of) the at least one CN-to-BS message (see, e.g., events 404, 408, 423, 438). When the CN node determines that the MBS session does not require UL resources, the flow proceeds from block 906 to block 910. At block 910, the CN node transmits the at least one CN-to-BS message to the at least one base station (see, e.g., events 404, 408, 423, 438).

Next, FIG. 10 illustrates another example method 1000 for determining whether to indicate, in a CN-to-BS message, that uplink (UL) resources are required for an MBS session, which can be implemented in a suitable CN node (e.g., AMF 164). The method 1000 is similar to the method 900, except that, instead of indicating that UL resources are required by including an UL resources required indication in the CN-to-BS message, the CN indicates that UL resources are required by excluding a DL-only resources indication from the CN-to-BS message. The method 1000 begins at block 1002, where the CN node determines to request at least one base station to configure resources for an MBS session. At block 1004, the CN node includes an MBS session ID of the MBS session in at least one CN-to-BS message (see, e.g., events 404, 408, 423, 438). At block 1006, the CN node determines whether the MBS session requires DL-only resources. When the CN node determines that the MBS session requires DL-only resources, the flow proceeds to block 1008, and from block 1008 to block 1010. At block 1008, the CN node includes an indication indicating DL-only resources required in the at least one CN-to-BS message (see, e.g., events 404, 408, 423, 438). When the CN determines that the MBS session does not require DL-only resources, the flow proceeds from block 1006 to block 1010. At block 1010, the CN transmits the CN-to-BS message to the at least one base station (see, e.g., events 404, 408, 423, 438).

Referring to FIG. 9 or 10, in some implementations, the at least one base station include multiple base stations and the CN node can transmit the CN-to-BS message to each of the multiple base stations. In other implementations, the at least one base station include multiple base stations (e.g., 1, . . . , N, where N>1) and the at least one CN-to-BS message includes multiple CN-to-BS messages (e.g., 1, . . . , N, where N>1) and the CN node can transmit the CN-to-BS messages 1, . . . N to the base stations 1, . . . N, respectively.

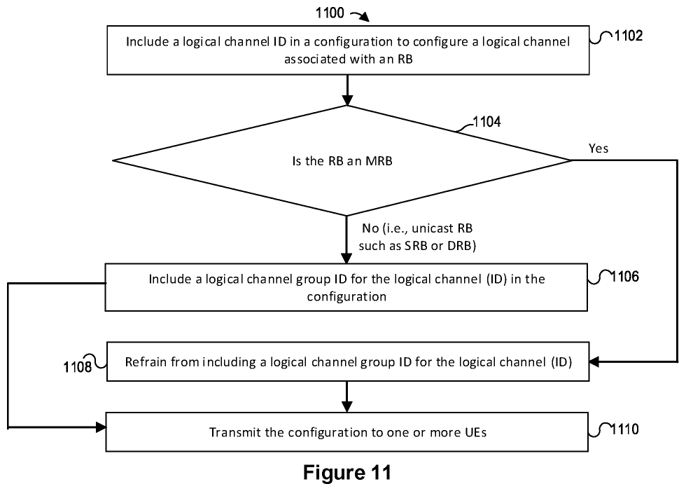

FIG. 11 illustrates an example method 1100 for determining, at a base station (e.g., the base station 104), whether to configure a logical channel group for an RB, based on whether the RB is a unicast RB or an MRB. The method 1100 begins at block 1102, where the base station includes a logical channel ID in a configuration to configure a logical channel associated with an RB (see, e.g., event 410, 424, 425). At block 1104, the base station determines whether the RB is an MRB. When the base station determines the RB is a unicast RB (e.g., SRB or DRB), the flow proceeds to block 1106. At block 1106, the base station includes a logical channel group ID for the logical channel (ID) in the configuration (see, e.g., event 410, 424, 425). Otherwise, when the base station determines the RB is an MRB, the flow proceeds to block 1108. At block 1108, the base station refrains from including a logical channel group ID for the logical channel (ID). From block 1106 or 1108, the flow proceeds to block 1110. At block 1110, the base station transmits the configuration to one or more UEs (see, e.g., event 410, 424, 425).

FIG. 12 is a flow diagram of an example method 1200 for determining whether to transmit data packets via a logical channel of an RB based on whether the RB is an MRB or a unicast RB, respectively, which can be implemented in a UE (e.g., the UE 102A, 102B or 103). The method 1200 begins at block 1202, where the UE receives, from a RAN, a logical channel ID configuring a logical channel associated with an RB (see, e.g., event 410, 424, 425). At block 1204, the UE receives data via the logical channel from the RAN (see, e.g., event 418, 432, 433). At block 1206, the UE determines whether the RB is an MRB. When the UE determines the RB is not an MRB (e.g., unicast RB such as SRB or DRB), the flow proceeds to block 1208. At block 1208, the UE transmits data via the logical channel to the RAN. Otherwise, when the UE determines the RB is an MRB, the flow proceeds to block 1210. At block 1210, the UE refrains from transmitting data via the logical channel to the RAN.

In some implementations, the UE may receive the at least one configuration parameter for the MRB from the RAN, as described for FIG. 5. In cases where the RB is an MRB, the UE may refrain from applying the at least one configuration parameter, as described for FIG. 5.

FIG. 13 is a flow diagram of an example method 1300 similar to the method 1200 of FIG. 12. The method 1300 begins at block 1302, where the UE receives from a RAN a logical channel ID configuring a logical channel associated with an MRB (see, e.g., event 410, 424, 425). At block 1304, the UE receives data via the logical channel from the RAN (see, e.g., event 418, 432, 433). At block 1306, the UE determines whether it receives at least one particular configuration parameter for the MRB. When the UE determines to receive at least one particular configuration parameter for the MRB, the flow proceeds to block 1308. At block 1308, the UE transmits data (e.g., PDCP control PDU or RLC Control PDU) via the logical channel to the RAN. Otherwise, when the UE determines not to receive at least one particular configuration parameter for the MRB, the flow proceeds to block 1310. At block 1310, the UE refrains from transmitting data via the logical channel to the RAN.

In some implementations, the UE may receive the at least one configuration parameter for the MRB from the RAN, as described for FIG. 5.

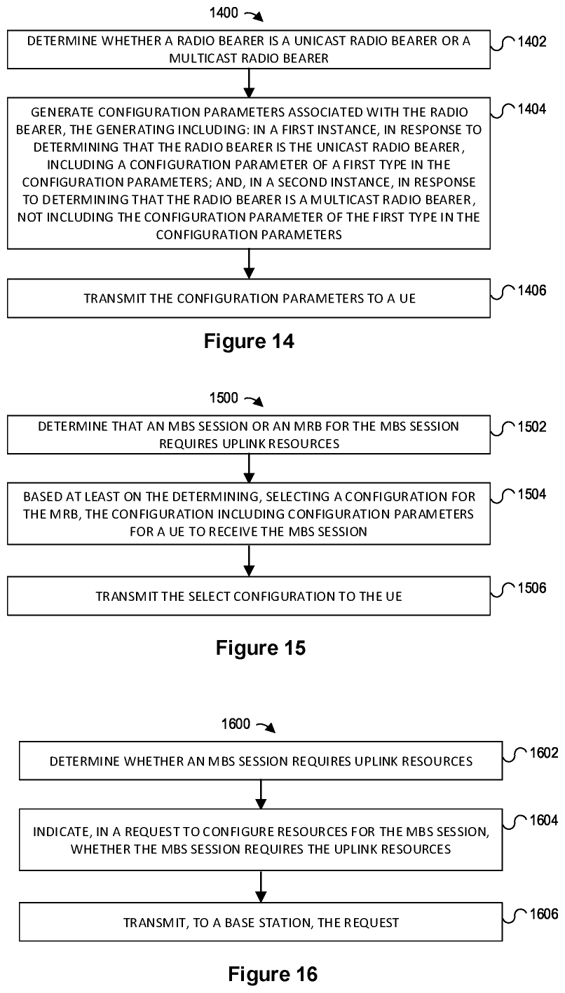

Turning to FIG. 14, a base station (e.g., the base station 104 or 106) can implement a method 1400 for configuring a radio bearer for a UE (e.g., the UE 102 or 103). The method 1400 may be implemented by processing hardware (e.g., the processing hardware 130 or 140). At block 1402, the base station determines whether the radio bearer is a unicast radio bearer or a multicast radio bearer (e.g., block 504, 604, 1104). At block 1404, the base station generates configuration parameters associated with the radio bearer. In response to determining that the radio bearer is the unicast radio bearer, the base station includes a configuration parameter of a first type in the configuration parameters (e.g., block 510, 606, 1106); and in response to determining that the radio bearer is the multicast radio bearer, the base station does not include the configuration parameter of the first type in the configuration parameters (e.g., block 516, 608, 1108). At block 1406, the base station transmits the configuration parameters to the UE (e.g., block 606, 608, 1110).

Referring to FIG. 15, a base station (e.g., the base station 104 or 106) can implement a method 1500 for configuring an MRB for an MBS session. The method 1500 may be implemented by processing hardware (e.g., the processing hardware 130 or 140). At block 1502, the base station determines that the MBS session or the MRB requires uplink resources (e.g., block 704, 806). At block 1504, based at least on the determining, the base station selects a configuration for the MRB, the configuration including configuration parameters for a UE (e.g., the UE 102 or 103) to receive the MBS session, and the base station transmits the selected configuration to the UE at block 1506 (e.g., block 706, 708, 808, 810).

Referring next to FIG. 16, a CN (e.g., the CN 110) can implement a method 1600 for configuring an MBS session. The method 1600 may be implemented by processing hardware. At block 1602, the CN determines whether the MBS session requires uplink resources (e.g., block 906, 1006). At block 1604, the CN indicates, in a request to configure resources for the MBS session, whether the MBS session requires the uplink resources (e.g., block 908, 1008). The CN transmits the request to a base station at block 1606 (e.g., block 910, 1010).

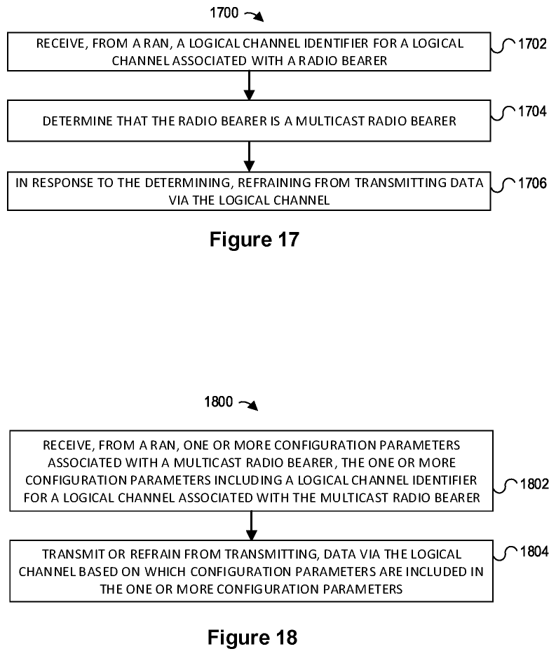

Turning to FIG. 17, a UE (e.g., the UE 102 or 103) can implement a method 1700 for communicating with a RAN (e.g., the RAN 105) The method 1700 may be implemented by processing hardware (e.g., the processing hardware 150). At block 1702, the UE receives, from the RAN, a logical channel identifier (e.g., a logical channel ID) for a logical channel associated with a radio bearer (e.g., block 1202). At block 1704, the UE determines that the radio bearer is a multicast radio bearer (MRB) (e.g., block 1206). At block 1706, in response to the determining, the UE refrains from transmitting data via the logical channel (e.g., block 1210).

Referring to FIG. 18, a UE (e.g., the UE 102 or 103) can implement a method 1800 for communicating with a RAN (e.g., the RAN 105) The method 1800 may be implemented by processing hardware (e.g., the processing hardware 150). At block 1802, the UE receives, from the RAN, one or more configuration parameters associated with a multicast radio bearer, the one or more configuration parameters including a logical channel identifier for a logical channel associated with the multicast radio bearer (e.g., block 1302). At block 1804, the UE transmits, or refrains from transmitting, data via the logical channel based on which configuration parameters are included in the one or more configuration parameters (e.g., block 1306, 1308, 1310).

The following list of examples reflects a variety of the embodiments explicitly contemplated by the present disclosure:

Example 1. A method in a base station for configuring a radio bearer for a user equipment (UE), the method comprising: determining, by processing hardware of the base station, whether the radio bearer is a unicast radio bearer or a multicast radio bearer; generating, by the processing hardware, configuration parameters associated with the radio bearer, the generating including: in a first instance, in response to determining that the radio bearer is the unicast radio bearer, including a configuration parameter of a first type in the configuration parameters; and in a second instance, in response to determining that the radio bearer is the multicast radio bearer, not including the configuration parameter of the first type in the configuration parameters; and transmitting, by the processing hardware, the configuration parameters to the UE.

Example 2. The method of example 1, wherein the configuration parameter includes an uplink configuration parameter.

Example 3. The method of example 2, wherein the uplink configuration parameter is associated with a medium access control (MAC) layer protocol.

Example 4. The method of any one of the preceding examples, wherein the configuration parameter includes a logical channel group identifier for a logical channel associated with the radio bearer.

Example 5. The method of any one of examples 1-3, wherein the configuration parameter includes a logical channel configuration.

Example 6. The method of any one of the preceding examples, wherein the configuration parameter includes at least one of: a subcarrier spacing list; a scheduling request identifier; a timer value; a physical priority index; a channel access priority; or a bitrate multiplier.

Example 7. The method of any one of the preceding examples, wherein generating the configuration parameters includes: in the first instance, generating a cell group configuration including the configuration parameter; and in the second instance, generating the cell group configuration not including the configuration parameter.

Example 8. The method of any one of the preceding examples, wherein generating the configuration parameters includes: in the first instance, generating a configuration for a radio link control (RLC) bearer associated with the radio bearer, the configuration including the configuration parameter; and in the second instance, generating the configuration for the RLC bearer, the configuration not including the configuration parameter.

Example 9. The method of any one of the preceding examples, wherein generating the configuration parameters includes: in the first instance, generating a unicast radio bearer configuration including the configuration parameter; and in the second instance, generating a multicast radio bearer configuration not including the configuration parameter.

Example 10. The method of any one of the preceding examples, wherein generating the configuration parameters includes: in the first instance, including, in the configuration parameters, a data radio bearer identifier (DRB ID); and in the second instance, including, in the configuration parameters, a multicast radio bearer identifier (MRB ID).

Example 11. A method in a base station for configuring a multicast radio bearer (MRB) for a multicast and/or broadcast services (MBS) session, the method comprising: determining, by processing hardware of the base station, that the MBS session or the MRB requires uplink resources; based at least on the determining, selecting, by the processing hardware, a configuration for the MRB, the configuration including configuration parameters for a user equipment (UE) to receive the MBS session; and transmitting, by the processing hardware, the selected configuration to the UE.

Example 12. The method of example 11, wherein the determining includes: determining that the MRB or the MBS session requires the uplink resources based on quality of service (QOS) parameters associated with the MBS session.

Example 13. The method of example 12, wherein the determining includes: determining that the MRB or the MBS session requires the uplink resources based on a QoS flow ID included in the QoS parameters.

Example 14. The method of example 12, wherein the determining includes: determining that the MRB or the MBS session requires the uplink resources based on which parameters are included in the QoS parameters.

Example 15. The method of example 12, wherein the determining includes: determining that the MRB or the MBS session requires the uplink resources in response to identifying that the QoS parameters include a QoS parameter for uplink.

Example 16. The method of example 15, wherein the QoS parameter for uplink includes a UE aggregate maximum bit rate for uplink.

Example 17. The method of any one of examples 12-16, further comprising: receiving, by the processing hardware, the QoS parameters in a message from a core network (CN) requesting that the base station configure resources for the MBS session.

Example 18. The method of any one of examples 12-16, wherein the determining includes: determining that the MRB or the MBS session requires the uplink resources based on the QoS parameters preconfigured at the base station.

Example 19. The method of example 11, further comprising: receiving, by the processing hardware, a message from a core network (CN) requesting that the base station configure resources for the MBS session; wherein the determining is based on the message.

Example 20. The method of example 19, wherein the determining includes: determining that the MRB or the MBS session requires the uplink resources based on identifying that the message includes an indication that the MBS session requires the uplink resources.

Example 21. The method of example 19, wherein the determining includes: determining that the MRB or the MBS session requires the uplink resources based on identifying that the message does not include an indication that the MBS session requires only downlink resources.

Example 22. The method of example 11, wherein the selecting includes selecting the MRB configuration that includes a particular configuration parameter.

Example 23. The method of example 22, wherein the particular configuration parameter includes at least one of: a logical channel configuration; an uplink configuration parameter; a logical channel group identifier; a subcarrier spacing list; a scheduling request identifier; a timer value; a physical priority index; a channel access priority; or a bitrate multiplier.

Example 24. A base station including processing hardware and configured to implement a method according to any one of the preceding examples.

Example 25. A method in a core network (CN) for configuring a multicast and/or broadcast services (MBS) session, the method comprising: determining, by processing hardware of the CN, whether the MBS session requires uplink resources; indicating, by the processing hardware, in a request to configure resources for the MBS session, whether the MBS session requires the uplink resources; and transmitting, by the processing hardware, to a base station, the request.

Example 26. The method of example 25, wherein the indicating includes: in a first instance, if the MBS session requires the uplink resources, including, in the request, an indication that the MBS session requires the uplink resources; and in a second instance, if the MBS session does not require the uplink resources, excluding, from the request, the indication.

Example 27. The method of example 25, wherein the indicating includes: in a first instance, if the MBS session does not require the uplink resources, including, in the request, an indication that the MBS session requires only downlink resources; and in a second instance, if the MBS session requires the uplink resources, excluding, from the request, the indication.

Example 28. The method of any one of examples 25-27, wherein transmitting the request includes: transmitting the request formatted in accordance with a Next Generation (NG) Application Protocol (NGAP).

Example 29. The method of example 28, wherein transmitting the request includes: transmitting an MBS Session Resource Setup Indication message.

Example 30. The method of example 28, wherein transmitting the request includes: transmitting a RAN Configuration Update message.

Example 31. A system including processing hardware and configured to implement a method according to any one of examples 25-30.

Example 32. A method in a user equipment (UE) for communicating with a radio access network (RAN), the method comprising: receiving, by processing hardware of the UE from the RAN, a logical channel identifier for a logical channel associated with a radio bearer; determining, by the processing hardware, that the radio bearer is a multicast radio bearer; and in response to the determining, refraining, by the processing hardware, from transmitting data via the logical channel.

Example 33. The method of example 32, further comprising: receiving, by the processing hardware from the RAN, at least one configuration parameter associated with the radio bearer; and in response to the determining, refraining from applying the at least one configuration parameter.

Example 34. The method of example 33, wherein the at least one configuration parameter includes an uplink configuration parameter.

Example 35. The method of example 34, wherein the uplink configuration parameter is associated with a medium access control (MAC) layer protocol.

Example 36. The method of any one of examples 33-35, wherein the at least one configuration parameter includes a logical channel group identifier.

Example 37. The method of any one of examples 33-36, wherein the at least one configuration parameter includes at least one of: a subcarrier spacing list; a scheduling request identifier; a timer value; a physical priority index; a channel access priority; or a bitrate multiplier.

Example 38. A method in a user equipment (UE) for communicating with a radio access network (RAN), the method comprising: receiving, by processing hardware of the UE from the RAN, one or more configuration parameters associated with a multicast radio bearer, the one or more configuration parameters including a logical channel identifier for a logical channel associated with the multicast radio bearer; and transmitting or refraining from transmitting, by the processing hardware, data via the logical channel based on which configuration parameters are included in the one or more configuration parameters.

Example 39. The method of example 38, wherein the transmitting or refraining from transmitting includes: transmitting the data in response to determining that a particular configuration parameter is included in the one or more configuration parameters.

Example 40. The method of example 38, wherein the transmitting or refraining from transmitting includes: refraining from transmitting the data in response to determining that a particular configuration parameter is not included in the one or more configuration parameters.

Example 41. The method of example 39 or 40, wherein the particular configuration parameter includes an uplink configuration parameter.

Example 42. The method of example 41, wherein the uplink configuration parameter is associated with a medium access control (MAC) layer protocol.

Example 43. The method of any one of examples 39-42, wherein the particular configuration parameter includes a logical channel group identifier.

Example 44. The method of any one of examples 39-43, wherein the particular configuration parameter includes at least one of: a subcarrier spacing list; a scheduling request identifier; a timer value; a physical priority index; a channel access priority; or a bitrate multiplier.

Example 45. A user equipment (UE) including processing hardware and configured to implement a method according to any one of examples 32-44.

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”.

A user device in which the techniques of this disclosure can be implemented (e.g., the UE 102A or 102B) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for communicating MBS information through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method in a base station for configuring a multicast radio bearer (MRB) for a multicast and/or broadcast services (MBS) session, the method comprising:
determining, by the base station, that the MBS session or the MRB requires uplink resources;
based at least on the determining, selecting, by the base station, a configuration for the MRB, the configuration including configuration parameters for a user equipment (UE) to receive the MBS session; and
transmitting, by the base station, the selected configuration to the UE.

2. The method of claim 1, wherein the determining that the MBS session or the MRB requires uplink resources includes:
determining that the MRB or the MBS session requires the uplink resources based on quality of service (QOS) parameters associated with the MBS session.

3. The method of claim 2, wherein the determining that the MBS session or the MRB requires uplink resources includes:
determining that the MRB or the MBS session requires the uplink resources based on a QoS flow ID included in the QoS parameters.

4. The method of claim 2, wherein the determining that the MBS session or the MRB requires uplink resources includes:
determining that the MRB or the MBS session requires the uplink resources based on which parameters are included in the QoS parameters.

5. The method of claim 2, wherein the determining that the MBS session or the MRB requires uplink resources includes:
determining that the MRB or the MBS session requires the uplink resources in response to identifying that the QoS parameters include a QoS parameter for uplink.

6. The method of claim 5, wherein the QoS parameter for uplink includes a UE aggregate maximum bit rate for uplink.

7. The method of claim 2, further comprising:
receiving, by the base station, the QoS parameters in a message from a core network (CN) requesting that the base station configure resources for the MBS session.

8. The method of claim 2, wherein the determining that the MBS session or the MRB requires uplink resources includes:
determining that the MRB or the MBS session requires the uplink resources based on the QoS parameters preconfigured at the base station.

9. The method of claim 1, further comprising:
receiving, by the base station, a message from a core network (CN) requesting that the base station configure resources for the MBS session,
wherein the determining that the MBS session or the MRB requires uplink resources is based on the message.

10. The method of claim 9, wherein the determining that the MBS session or the MRB requires uplink resources includes:
determining that the MRB or the MBS session requires the uplink resources based on identifying that the message includes an indication that the MBS session requires the uplink resources.

11. The method of claim 9, wherein the determining that the MBS session or the MRB requires uplink resources includes:
determining that the MRB or the MBS session requires the uplink resources based on identifying that the message does not include an indication that the MBS session requires only downlink resources.

12. The method of claim 1, wherein the selecting includes selecting the MRB configuration that includes a particular configuration parameter.

13. The method of claim 12, wherein the particular configuration parameter includes an uplink configuration parameter.

14. The method of claim 12, wherein:
the selecting includes selecting a logical channel configuration of a logical channel associated with the MRB.

15. An apparatus operating as a base station, configured to configure a multicast radio bearer (MRB) for a multicast and/or broadcast services (MBS) session, the apparatus comprising:
a transceiver; and
processing hardware configured to:
determine that the MBS session or the MRB requires uplink resources;
based at least on the determining, select a configuration for the MRB, the configuration including configuration parameters for a user equipment (UE) to receive the MBS session; and
transmit the selected configuration to the UE.

16. The apparatus of claim 15, wherein determining that the MBS session or the MRB requires uplink resources includes:
determining that the MRB or the MBS session requires the uplink resources based on quality of service (QOS) parameters associated with the MBS session.

17. The apparatus of claim 16, wherein determining that the MBS session or the MRB requires uplink resources includes:
determining that the MRB or the MBS session requires the uplink resources based on a QoS flow ID included in the QoS parameters.

18. The apparatus of claim 16, wherein determining that the MBS session or the MRB requires uplink resources includes:
determining that the MRB or the MBS session requires the uplink resources based on which parameters are included in the QoS parameters.

19. The apparatus of claim 16, wherein determining that the MBS session or the MRB requires uplink resources includes:
determining that the MRB or the MBS session requires the uplink resources in response to identifying that the QoS parameters include a QoS parameter for uplink.

20. The apparatus of claim 19, wherein the QoS parameter for uplink includes a UE aggregate maximum bit rate for uplink.
